(19) United States
(12) Patent Application Publication
(10) Pub. No.: US 2013/0301493 A1
(43) Pub. Date: Nov. 14, 2013

(54) METHOD OF TRANSMITTING DATA

(71) Applicants: Min-Hong YUN, Daejeon (KR); Cheol RYU, Daejeon (KR); Do-Hyung KIM, Daejeon (KR); Jae-Ho LEE, Daejeon (KR)

(72) Inventors: Min-Hong YUN, Daejeon (KR); Cheol RYU, Daejeon (KR); Do-Hyung KIM, Daejeon (KR); Jae-Ho LEE, Daejeon (KR)

(73) Assignee: ELECTRONICS & TELECOMMUNICATIONS RESEARCH INSTITUTE, Daejeon (KR)

(21) Appl. No.: 13/594,123

(22) Filed: Aug. 24, 2012

(30) Foreign Application Priority Data
May 8, 2012 (KR) 10-2012-0048584

(51) Int. Cl. H04B 7/00; H04L 12/56

(52) U.S. Cl. 370/310

(57) ABSTRACT

Disclosed herein are a method of transmitting data and a method of receiving data. In the method of transmitting data, a management frame including data to be transmitted is configured, and the configured management frame is transmitted. In the method of receiving data, a management frame is received and then data is read from the received management frame.

### CROSS REFERENCE TO RELATED APPLICATION

This application claims the benefit of Korean Patent Application No. 10-2012-0048584, filed on May 8, 2012, which is hereby incorporated by reference in its entirety into this application.

### BACKGROUND OF THE INVENTION

1. Technical Field

The present invention relates generally to the transmission of data and, more particularly, to a method of transmitting small size data.

2. Description of the Related Art

With the recent explosive popularization of smart phones, there has been an increase in devices that are equipped with wireless communication means, particularly 802.11 (Wi-Fi) functionality. Such devices may be equipped with communication means, such as Bluetooth or Infrared Data Association (IrDA), depending on the purposes of use thereof.

Methods of transmitting and receiving data using the 802.11 technology may be classified into two types. The first type of method is a method that accesses an existing access point (AP) and establishes a network, and the second type of method is an ad hoc method that temporarily establishes a network with surrounding devices.

Here, the most widely used method that accesses an existing AP and establishes and utilizes a network is referred to as infrastructure mode, and is widely used in smart phones, notebook computers, and desktop computers.

Meanwhile, the ad hoc method that temporarily establishes a network with surrounding devices has the advantage of enabling communication between devices without requiring an AP. With regard to some portable games, a network is established between portable gaming devices using the ad hoc method and battle games are played over the network.

However, both the method that accesses an existing AP and establishes and utilizes a network and the ad hoc method that temporarily establishes a network with surrounding devices are configured to exchange messages after a network has been established.

If a network is established as described above and then large size data is transmitted and received, the cost of establishing the network can be tolerated. However, if the size of data to be transmitted or received is substantially a few bytes, it is inefficient to establish a network to transmit or receive such data.

Korean Unexamined Patent Publication No. 2009-0005649 discloses a state transition method that is used to perform peer-to-peer (P2P) communication in a mobile communication system. The method disclosed in the above Korean patent publication is merely a technology that handles a message requesting P2P communication even when a device is in sleep mode or inactive mode, and ultimately requires the establishment of a network.

Accordingly, there is an urgent need for a technology that is capable of transmitting and receiving data without establishing a network when the cost of establishing a network to transmit and receive data is higher than the cost of transmitting and receiving data because the size of data to be transmitted and received is small.

### SUMMARY OF THE INVENTION

Accordingly, the present invention has been made keeping in mind the above problems occurring in the prior art, and an object of the present invention is to provide a method of transmitting data, which is capable of transmitting data fast.

In order to accomplish the above object, the present invention provides a method of transmitting data, including configuring a management frame including data to be transmitted; and transmitting the configured management frame.

The method may further include determining the size of the data to be transmitted; wherein the configuring a management frame may include, if the size of the data to be transmitted satisfies a preset condition, configuring the management frame including the data to be transmitted.

The management frame may include a Media Access Control (MAC) header, a frame body including the data to be transmitted, and Frame Check Sequence (FCS)/Cyclic Redundancy Check (CRC).

The configuring a management frame may include including the data to be transmitted in a vendor specific data field of the frame body.

The transmitting the management frame may include transmitting at least one of a probe request message and a beacon signal.

In order to accomplish the above object, the present invention provides a method of receiving data, including receiving a management frame; and reading data from the received management frame.

The receiving a management frame may include receiving at least one of a probe request message and a beacon signal.

The reading data from the received management frame may include reading data from a vendor specific data field of a frame body among a MAC header, the frame body including the data, and FCS/CRC that are included in the received management frame.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a signal sequence diagram showing a method of transmitting data;

FIG. 2 is a conceptual diagram showing the configuration of a management frame;

FIG. 3 is a conceptual diagram showing the concept of transmitting and receiving data without establishing a network between devices according to an embodiment of the present invention; and

FIG. 4 is a flowchart showing a method of transmitting data without establishing a network according to an embodiment of the present invention.

### DESCRIPTION OF THE PREFERRED EMBODIMENTS

The present invention will be described below in detail with reference to the accompanying drawings. In the following description, repetitive descriptions and detailed descriptions of well-known functions or configurations which would unnecessarily obscure the gist of the present invention will be omitted. Embodiments of the present invention are provided to complete descriptions for those skilled in the art of the present invention. Therefore, the shapes and sizes of components in the drawings may be exaggerated to provide more precise descriptions.

The term “device” that is used in this specification and the following claims may be referred to as a mobile station (MS), user equipment (UE), a user terminal (UT), a wireless terminal, an access terminal (AT), a subscriber unit (SU), a Subscriber Station (SS), a wireless device, a wireless communication device, a wireless transmit/receive unit (WTRU), a mobile node, a mobile port, or some other term.

The variety of embodiments of the device may not only include a cellular phone, a smart phone having wireless communication functionality, a personal digital assistant (PDA) having wireless communication functionality, a wireless modem, a gaming device having wireless communication functionality, a music storage and playback appliance having wireless communication functionality, and an Internet home appliance having wireless Internet access and browsing functionality but may also include a portable unit or terminal having a combination of such functionalities, but are not limited thereto.

Preferred embodiments according to the present invention will be described in detail below with reference to the accompanying drawings.

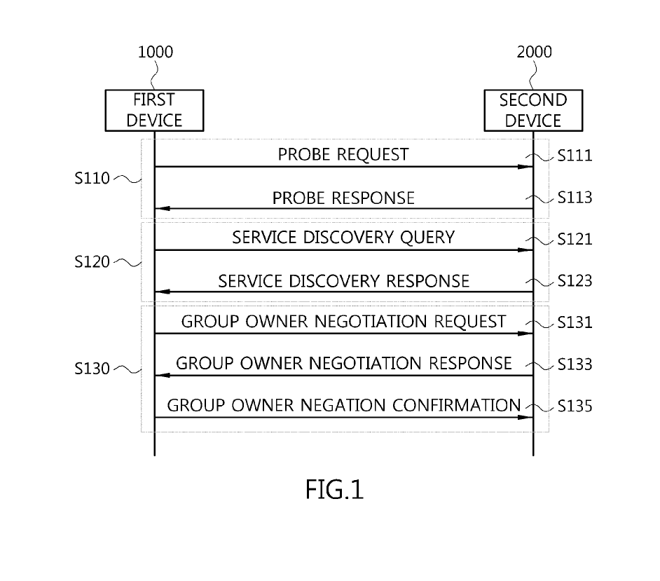

FIG. 1 is a signal sequence diagram showing a method of transmitting data.

It is assumed that a first device 1000 and a second device 2000 operate independently without establishing a network in their initial stage.

Referring to FIG. 1, the first device 1000 and the second device 2000 establish a network after undergoing a device discovery step S110, a service discovery step S120 and a group formation step S130 to set up a connection via which data will be exchanged.

More specifically, the first device 1000 transmits a probe request message to the second device 2000 so as to exchange data with the second device 2000 at step S111.

Thereafter, the second device 2000 generates a probe response message corresponding to the probe request message received from the first device 1000 and transmits the generated probe response message to the first device 1000 at step S113.

Here, the first device 1000 may determine that the second device 2000 is present around the first device 1000 after undergoing steps 111 and 113, and may then establish a channel with the second device 2000 to exchange data.

Thereafter, the first device 1000 transmits a service discovery query message to the second device 2000 at step S121.

The second device 2000 generates a service discovery response message corresponding to the service discovery query message received from the first device 1000 and transmits the generated service discovery response message to the first device 1000 at step S123.

Here, the first device 1000 may determine the type of service provided by the second device 2000 after undergoing steps 121 and 123.

Thereafter, the first device 1000 transmits a group owner negotiation request message to the second device 2000 at step S131.

The second device 2000 generates a group owner negotiation response message corresponding to the group owner negotiation request message received from the first device 1000 and transmits the generated group owner negotiation response message to the first device 1000 at step S133.

The first device 1000 generates a group owner negotiation confirmation message corresponding to the group owner negotiation response message received from the second device 2000 and transmits the generated group owner negotiation conformation message to the second device 2000 at step S135.

Here, the term “group owner” refers to a device having a higher owner intention value when the owner intention values of the first and second devices 1000 and 2000 are compared with each other.

Furthermore, the larger the number of CPU clocks is, the higher the remaining battery capacity is or the more continuously power is supplied, the higher the owner intention value becomes.

After undergoing steps S131 to S135, the first and second devices 1000 and 2000 establish a group to perform communication.

Here, communication between the first and second devices 1000 and 2000 may be performed using a variety of wireless communication technologies such as not only 802.11x (for example, 802.11a, 802.11b, 802.11g, 802.11n, 802.11ac, etc.), but also Bluetooth, Zigbee, Ultra Wide Band (UWB) communication, Near Field Communication (NFC), Binary Division Multiple Access (B-CDMA), and Long Term Evolution (LTE).

As described above, the first and second devices 1000 and 2000 should establish a network regardless of the size of data to exchange data. A method of transmitting data without establishing a network when the size of data is small according to an embodiment of the present invention method will now be described.

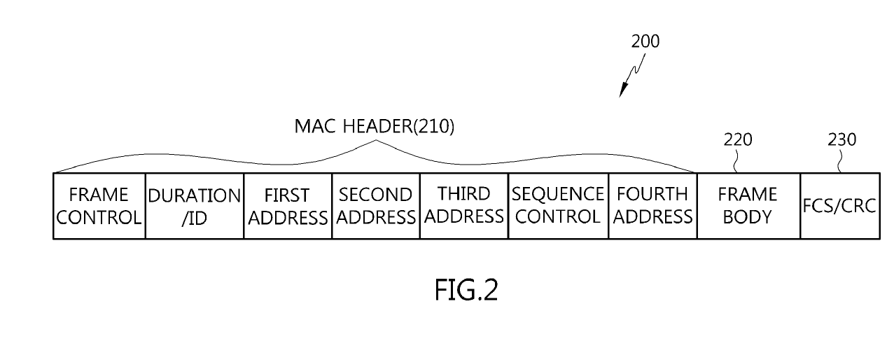

FIG. 2 is a conceptual diagram showing the configuration of a management frame.

Data that is exchanged between Wi-Fi devices is referred to as a frame. Such a frame may be classified as a control frame, a management frame 200, or a data frame.

Here, the control frame is used for the MAC control of a wireless channel, like an ACK, an RTS or the like, the management frame is used as a beacon and to perform device management such as the setup of a connection, authentication and the like, and the data frame is used as the unit of information that is transmitted in the form of a single block or packet.

Referring to FIG. 2, the management frame 200 may include an MAC header 210, a frame body 220, and an FCS/CRC 230.

First, the MAC header 210 may include a frame control, a duration/ID, first to fourth addresses, and a sequence control.

Here, the field of the duration includes a Net Allocation Vector (NAV) value that is a time value that is used to reserve the use of a wireless link so that the use of the channel of the other devices is stopped for a predetermined period.

Here, the most significant bit value is 0, and the remaining 15 bit value is an NAV value on a usec basis. Furthermore, the field of the address uses a 6-byte address.

The frame body 220 includes a Service Set Identification (SSID). If the management frame 200 is used for a probe request or a beacon, data of a size equal to or smaller than a preset number of reference bytes may be contained in the vendor specific data field of the frame body 220, which can be used by a vendor.

More specifically, the size of the frame body 230 may range from 0 to 2312 bytes and the size of the vendor specific data may also range from 0 to 2312 bytes. In an embodiment of the present invention, data of a size equal to or smaller than the preset number of reference bytes is contained in the vendor specific data field, so that the data can be transferred to some other device.

That is, conventional devices establish a network after undergoing the device discovery step 110, the service discovery step 120 and the group formation step 130 of FIG. 1, and exchange data with each other.

However, since a message of a size equal to or smaller than a preset number of reference bytes may be transmitted and received at the device discovery step 110 according to an embodiment of the present invention, there is the advantage of reducing the cost of performing the service discovery step 120 and the group formation step 130.

Furthermore, if the management frame 200 is used for a beacon, a message of a size equal to or smaller than the preset number of reference bytes may be transmitted and received without undergoing the device discovery step 110 according to an embodiment of the present invention.

The FCS/CRC 230 is used to prevent errors. FCS stands for frame check sequence, and is indicative of a frame check sequence.

Furthermore, CRC stands for cyclic redundancy check, and refers to a mathematical technique that detects data, for example, when the data is transmitted to a modem. CRC transmits a NAK signal until a CRC calculation becomes correct.

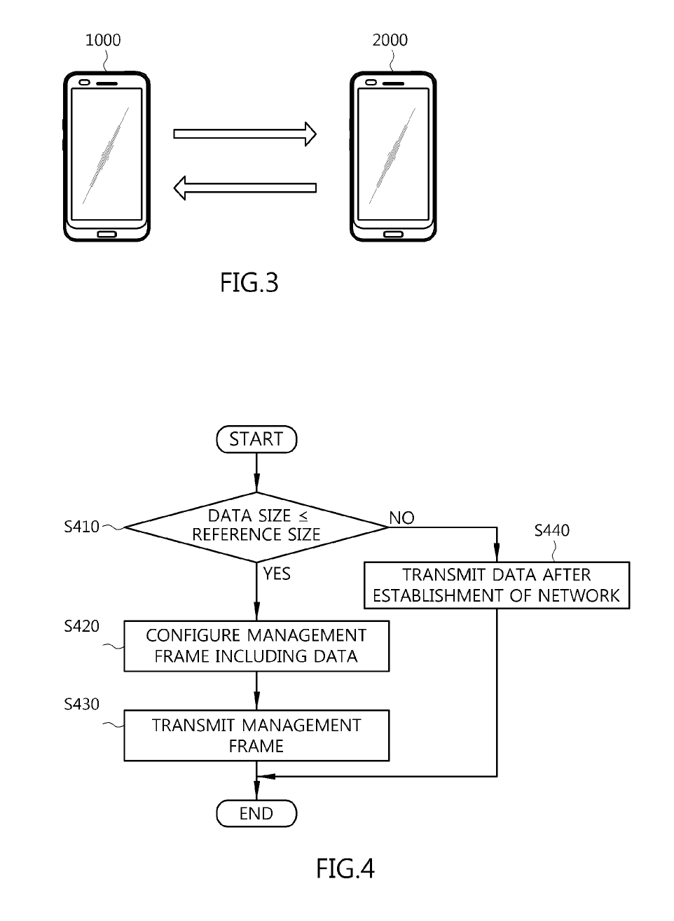

FIG. 3 is a conceptual diagram showing the concept of transmitting and receiving data without establishing a network between devices according to an embodiment of the present invention.

Referring to FIG. 3, if the management frame 200 of FIG. 2 is used for a probe request, the first device 1000 may include data of a size equal to or smaller than the preset number of reference bytes in the vendor specific data field of the frame body 220 and then transmit the data to the second device 2000 in response to the transmission of the probe request message.

Here, the second device 2000 may receive the management frame from the first device 1000 and then read data from the received management frame.

More specifically, the second device 2000 may receive the management frame via the probe request message received from the first device 1000 and then read data from the vendor specific data field of the frame body, which constitutes part of the management frame.

Alternatively, if the management frame 220 of FIG. 2 is used for a beacon, the first device 1000 may include data of a size equal to or smaller than the preset number of reference bytes in the vendor specific data field of the frame body 220, and transmit a message of a size equal to or smaller than the preset number of reference bytes to the second device 2000 in response to the transmission of a beacon message.

Here, the second device 2000 may receive the management frame from the first device 1000 and then read data from the received management frame.

More specifically, the second device 2000 may receive the management frame via the beacon signal received from the first device 1000 and then read data from the vendor specific data field of the frame body, which constitutes part of the management frame.

FIG. 4 is a flowchart showing a method of transmitting data without establishing a network according to an embodiment of the present invention.

Referring to FIG. 4, a device determines whether the size of input data is equal to or smaller than a preset number of reference bytes at step S410.

If it is determined that the size of the input data is equal to or less than the preset number of reference bytes at step 410, the device includes the input data in the frame body of the management frame at step S420.

In an embodiment, the method of transmitting data without establishing a network according to the present invention may include input data in the frame body of the management frame regardless of the size of the input data.

Here, if the function of the management frame is intended for a probe request or beacon, the device may include data of a size equal to or smaller than the preset number of reference bytes in the vendor specific data field of the frame body, which can be used by a vendor.

Thereafter, the device transmits the management frame to another device at step S430.

Here, the device may transfer the input data to the other device in such a way that the device transmits a beacon signal or a probe request message to the other device.

As a result, the device can transmit data to another device without establishing a network with the other device, thereby enabling fast data transmission and reception.

Alternatively, if it is determined that the size of the input data exceeds the preset number of reference bytes at step 410, the device may establish a network at the device discovery step, the service discovery step and the group formation step and then transmit the input data to the other device over the established network at step S440.

Although the embodiment of the present invention has illustrated the method by which a device transmits data to another device, the reception of data from another device is enabled without establishing a network according to another embodiment of the present invention.

That is, a management frame is received from the other device, and data is read from the received management frame. Here, the reception of the management frame may be performed using at least one of a probe request message and a beacon signal that are received from the other device.

More specifically, since the management frame includes a MAC header, a frame body including data transmitted by the other device, and an FCS/CRC, the device may read data from the vendor specific data field of the frame body.

In accordance with the present invention, the cost of establishing a network can be reduced and thus fast data transmission and reception are enabled.

Furthermore, in accordance with the present invention, the cost of establishing a network can be reduced in an environment in which the users of Wi-Fi P2P devices are moving continuously and thus data can be transmitted faster.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of transmitting data, comprising:
configuring a management frame including data to be transmitted; and
transmitting the configured management frame.

2. The method of claim 1, further comprising determining a size of the data to be transmitted;
wherein the configuring a management frame comprises, if the size of the data to be transmitted satisfies a preset condition, configuring the management frame including the data to be transmitted.

3. The method of claim 1, wherein the management frame comprises a Media Access Control (MAC) header, a frame body including the data to be transmitted, and Frame Check Sequence (FCS)/Cyclic Redundancy Check (CRC).

4. The method of claim 3, wherein the configuring a management frame includes the data to be transmitted in a vendor specific data field of the frame body.

5. The method of claim 1, wherein the transmitting the management frame transmits at least one of a probe request message and a beacon signal.

6. A method of receiving data, comprising:
receiving a management frame; and
reading data from the received management frame.

7. The method of claim 6, wherein the receiving a management frame receives at least one of a probe request message and a beacon signal.

8. The method of claim 6, wherein the reading data from the received management frame reads data from a vendor specific data field of a frame body among a MAC header, the frame body including the data, and FCS/CRC that are included in the received management frame.
